(19) United States
(12) Patent Application Publication
(10) Pub. No.: US 2024/0282157 A1
(43) Pub. Date: Aug. 22, 2024

(54) INFORMATION PROCESSING DEVICE

(71) Applicant: TOYOTA JIDOSHA KABUSHIKI KAISHA, Toyota-shi (JP)

(72) Inventors: Nariaki AMANO, Nagoya-shi (JP); Yukinori II, Toyota-shi (JP); Yusuke MAEDA, Miyoshi-shi (JP); Takeshi MURAKAMI, Okazaki-shi (JP); Atsuki SAKURAI, Toyota-shi (JP); Yuichiro YANO, Nagakute-shi (JP); Yuki KATAI, Toyota-shi (JP); Yoshiaki SUGIYAMA, Anjo-shi (JP); Taisei NISHIMORI, Okazaki-shi (JP); Seiichi TAGAWA, Nagoya-shi (JP); Shinichi TAKEDA, Nagoya-shi (JP); Yuta TONE, Nagoya-shi (JP)

(73) Assignee: TOYOTA JIDOSHA KABUSHIKI KAISHA, Toyota-shi (JP)

(21) Appl. No.: 18/422,170

(22) Filed: Jan. 25, 2024

(30) Foreign Application Priority Data
Feb. 20, 2023 (JP) 2023-024472

(51) Int. Cl. G07C 7/00; G07C 5/06

(52) U.S. Cl. CPC G07C 7/00; G07C 5/06

(57) ABSTRACT

A control unit of an information processing device acquires a request to add an item to a vehicle, acquires first information that is information according to whether the vehicle has a structure for adding an item, determining a fee for adding the item to the vehicle based on the one piece of information and the information about the item, and outputting the information about the fee.

### CROSS-REFERENCE TO RELATED APPLICATION

This application claims priority to Japanese Patent Application No. 2023-024472 filed on Feb. 20, 2023, incorporated herein by reference in its entirety.

### BACKGROUND

### 1. Technical Field

The present disclosure relates to an information processing device.

### 2. Description of Related Art

A technique is disclosed in which a device that detects following vehicles is integrated with the GPS unit so that the need for complicated wiring work is eliminated. With this technique, a user can install and use the device very easily by simply attaching the device to the vehicle's interior rear glass and inserting the car plug into the power socket (see, for example, Japanese Unexamined Patent Application Publication No. 2022-151444 (JP 2022-151444 A)).

### SUMMARY

An object of the present disclosure is to provide a technique that allows appropriately setting a charge for installing a retrofit item to a vehicle.

An aspect of the present disclosure is an information processing device including a control unit that executes: acquiring a request for adding an item to a vehicle; acquiring first information that is information according to whether the vehicle is structured such that the item is added; determining a charge for adding the item to the vehicle based on the first information and information about the item; and outputting information about the charge.

Furthermore, another aspect of the present disclosure is an information processing method by which a computer executes the processing of the information processing device, a program that causes a computer to execute the processing of the information processing device, and a storage medium that non-transitory stores the program.

According to the present disclosure, it is possible to provide a technique that allows appropriately setting a charge for installing a retrofit item.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram showing a schematic configuration of a system according to an embodiment;

FIG. 2 is a diagram showing an example of the hardware configuration of each of a user terminal and a center server that constitute the system according to the embodiment;

FIG. 3 is a diagram showing an example of the functional configuration of the center server;

FIG. 4 is a diagram showing an example of information stored in a vehicle information database (DB), an item information DB, and a charge information DB; and

FIG. 5 is a flowchart of processing in the center server according to the embodiment.

### DETAILED DESCRIPTION OF EMBODIMENTS

There is a technology for retroactively adding a function or part (hereinafter also referred to as an item) to a vehicle. For example, it is conceivable to retrofit a blind spot monitor (BSM) that detects vehicles approaching from the rear side of the vehicle. In such cases, it is necessary to add sensors to the rear of the vehicle. Furthermore, in order to send the output of the sensor to the electronic control unit (ECU), a wire harness having a connector to connect to the sensor is required. When a wire harness that has been equipped has no connector, it is necessary to replace the wire harness. In order to replace the wire harness, it is necessary to temporarily remove the interior parts, which increases the work time. Also, when adding a sensor, it may be necessary to drill a hole in the vehicle in order to attach the sensor itself to the vehicle, or it may be necessary to attach a bracket to fix the connector connected to the sensor. Such work also takes time.

Here, to have a structure (for example, a hole for attaching an item, a bracket for attaching an item, or a wire harness having a connector that connects to an item, etc.) assuming that an item is added after the fact, It is conceivable to design and manufacture the vehicle in advance. Then, for example, retrofit items can be added to the vehicle in a relatively short work time without requiring advanced work.

On the other hand, for vehicles that do not have a structure that assumes that items will be added after the fact, when adding retrofit items, additional work may be required such as drilling holes in the body, welding brackets to the body, or sheet metal working of the body. As a result, there is a possibility that the work of adding retrofit items will become sophisticated and that the work time will be lengthened.

Therefore, there is a possibility that the work level and work time for adding retrofit items will differ between the case where the vehicle has a structure that assumes that the item will be added after the fact and the case where the vehicle does not have such a structure. As a result, there arises a need to differentiate charges for adding retrofit items depending on whether or not the vehicle has a structure that assumes that the item will be added after the fact. Therefore, there is a need for a method for appropriately determining the charge for adding items depending on whether the vehicle has a structure that assumes that items will be added after the fact.

On the other hand, an information processing device, which is one aspect of the present disclosure, includes a control unit for executing obtaining a request to add an item to a vehicle, obtaining first information that is information according to whether the vehicle has a structure for adding the item, determining a charge for adding the item to the vehicle based on the first information and information about the item, and outputting information about the fee.

Items are devices, parts, or systems that can be retrofitted to a vehicle. A request to add an item to the vehicle is transmitted from the user's terminal to the information processing device, for example. The user's terminal may be a vehicle owner's terminal, or may be a car dealer's terminal or the like. The information according to whether the vehicle has a structure for adding items, which is included in the first information, is information regarding whether the vehicle has a structure on the assumption that items will be added after the fact. Such structures include, for example, information as to whether a wiring harness having a connector connectable to the item is attached to the vehicle. In that case, if a wire harness having a connector connectable to an item is attached to the vehicle in advance, it can be said that the vehicle has a structure for adding the item. Further, for example, information regarding whether or not the vehicle is provided with holes, brackets, or the like for attaching items in advance may be further included in the information according to whether the vehicle has a structure for adding items. The information according to whether the vehicle has a structure for adding items can be appropriately changed according to the retrofit items. Such information may be information associated with, for example, the vehicle body number, vehicle type, vehicle grade, vehicle model, and the like.

Here, even for the same item, it is assumed that the work level and work time are different depending on whether the vehicle has a structure for adding the item or not. Moreover, even for the same vehicle, it is assumed that the work level and work time will differ depending on the item to be added. Therefore, the control unit according to the present disclosure determines a fee for adding an item to the vehicle based on the first information and the information regarding the item. Then, the control unit outputs information about the determined fee. Outputting the information about the determined toll includes, for example, sending a command to the terminal of the user of the vehicle to display the information on the display.

According to the information processing device according to the present disclosure, it is possible to appropriately determine the charge for adding an item for each of cases where the vehicle has a structure for adding an item and where it does not. It is also possible to notify the user of the vehicle of the determined fee.

Hereinafter, embodiments of the present disclosure will be described with reference to the drawings. The configurations of the following embodiments are illustrative, and the present disclosure is not limited to the configurations of the embodiments. Further, the following embodiments can be combined as much as possible.

### First Embodiment

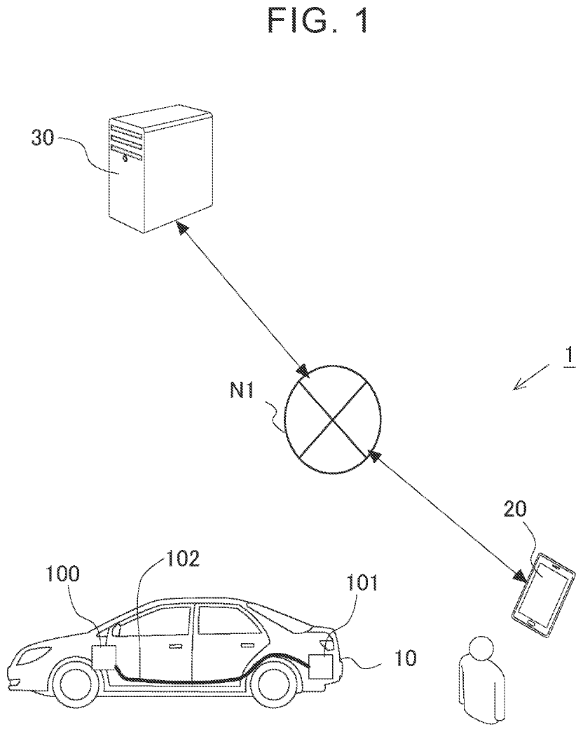

FIG. 1 is a diagram illustrating a schematic configuration example of a system 1 according to an embodiment of the present disclosure. In the example of FIG. 1, system 1 includes user terminal 20 and center server 30. The user terminal 20 is a terminal used by the user of the vehicle 10. A vehicle 10 is equipped with an in-vehicle device 100. Items can be added to the vehicle 10 illustrated in FIG. 1 after the fact. For example, if a blind spot monitor (BSM) is to be added to the vehicle 10, the sensor 101 etc. will be retrofitted to the vehicle 10. The BSM is a system that detects the approach of another vehicle from behind and supports the user's decision when changing lanes. The sensor 101 in this case is, for example, a radar sensor. A retrofitted sensor 101 is connected to the in-vehicle device 100 via a wire harness 102. The in-vehicle device 100 performs control of the vehicle 10, BSM, etc. by executing installed software. The software for controlling the BSM may be pre-installed in the in-vehicle device 100, or may be installed when the sensor 101 is retrofitted.

The center server 30 accepts addition of items to the vehicle 10 from the user terminal 20. Then, the center server 30 determines a charge for adding items to the vehicle 10 based on the structure of the vehicle 10 and the items. The center server 30 outputs (transmits) to the user terminal 20 a command to display the determined fee.

Here, the work of adding items in the present disclosure will be described. Vehicle 10 can be retrofitted or replaced with, for example, blind spot monitors (BSM), safety features, parking support brakes (PKSB), panoramic view monitors (PVM), steering heaters, seat upholsteries, and the like. BSM is a system that detects the approach of another vehicle from behind as described above and assists the user in making a decision when changing lanes. In order to add BSM functionality to the vehicle 10, a wire harness 102 having a sensor 101 and a connector connectable to the sensor 101 is required. In addition, it is necessary to replace the side mirrors, bumpers, etc. with those compatible with BSM. A bracket may be required for mounting the sensor 101 or mounting a connector connected to the sensor 101.

Safety features are packages that include, for example, Front Cross Traffic Alert (FCTA), Lane Change Assist (LCA), and Emergency Steering Assist. FCTA is a function that detects vehicles approaching from the left and right when entering an intersection or the like. The LCA is a function that assists steering when changing lanes and monitoring of vehicles ahead of the lane change. In order to add a safety function, it is necessary to add a sensor, replace the steering wheel, etc., and furthermore, wire harness 102 corresponding to these parts is required.

PKSB is a system that issues a warning and collision damage mitigation brake control when an object to be activated is detected during low-speed driving such as parking. A rearview camera and corresponding wire harness 102 are required to add PKSB functionality.

The PVM is a function of connecting images from cameras attached to the front, rear, left, and right of the vehicle 10, generating an image of the surroundings of the vehicle 10, and displaying the image on a display. Adding PVM functionality requires adding a camera and control unit (ECU) and replacing the front grille and side mirrors. Also, a wire harness 102 corresponding to these parts is required.

The steering heater is a function that warms the steering wheel. In order to add the function of the steering heater, it is necessary to replace the steering wheel and add a switch. Also, a wire harness 102 corresponding to these parts is required.

For the seat upholstery, it may be possible, for example, to replace it with a premium fabric and add a seat heater. Replacing with high-grade fabric is to change the seat covering to a higher-grade one. The seat heater has a function of warming the skin of the seat. Seat replacement and air conditioner controller replacement are required. Also, a wire harness 102 corresponding to these parts is required.

Here, in order to have the structure for adding the above items (that is, the structure assuming that the above items are added after the fact; hereinafter, it may be described as “ready structure”), it is conceivable to design and manufacture the vehicle in advance. The ready structure includes, for example, a structure in which a wire harness corresponding to the item is pre-attached to the vehicle body, a structure in which a hole for attaching the item is pre-drilled in the vehicle body, or a structure in which a bracket for attaching the item is pre-attached to the vehicle body. For vehicles with a ready structure, it becomes possible to add items in a relatively short working time without requiring advanced work. On the other hand, there may exist vehicles that do not have a ready structure. For vehicles that do not have a ready structure, additional work such as drilling holes in the body, welding brackets to the body, or sheet metal work is required, so that the work level may be high and the work time may be long. Therefore, a vehicle with a ready structure and a vehicle without a ready structure may differ in the work level and required time for adding items. Along with this, it may be necessary to differentiate the fee for adding an item between a vehicle with a ready structure and a vehicle without a ready structure. Therefore, the center server 30 of this embodiment determines the fee for adding an item according to the structure of the vehicle 10 and the item.

The user terminal 20 and the center server 30 are interconnected via the network N1. The network N1 is, for example, a worldwide public communication network such as the Internet, and may be a Wide Area Network (WAN) or other communication networks. The network N1 may also include a telephone communication network such as a mobile phone, or a wireless communication network such as Wi-Fi (registered trademark). Although one vehicle 10 and one user terminal 20 are illustrated in FIG. 1 as an example, multiple vehicles 10 and user terminals 20 may exist.

### Hardware Configuration

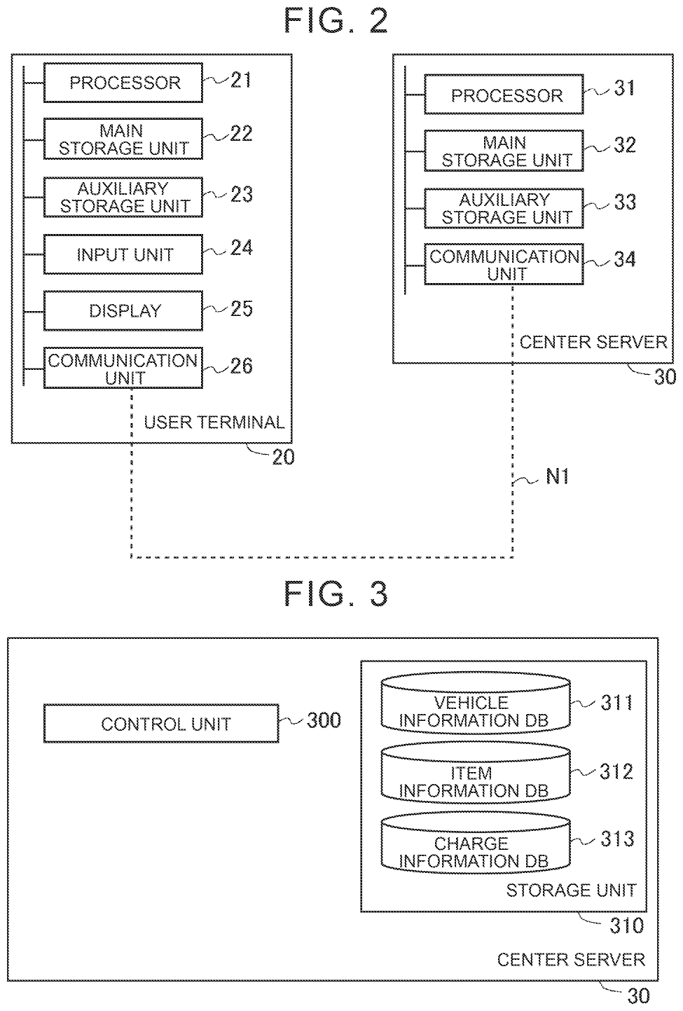

Here, hardware configurations of the user terminal 20 and the center server 30 will be described. FIG. 2 is a diagram showing an example of the hardware configuration of each of the user terminal 20 and the center server 30 that configure the system 1 according to the embodiment.

The center server 30 has a computer configuration. The center server 30 includes a processor 31, a main storage unit 32, an auxiliary storage unit 33, and a communication unit 34. The components above are connected to each other by a bus. The processor 31 is an example of a control unit.

The processor 31 is a Central Processing Unit (CPU), a Digital Signal Processor (DSP), or the like. The processor 31 controls the center server 30 and performs various information processing calculations. The main storage unit 32 is Random Access Memory (RAM), Read Only Memory (ROM), and the like. The auxiliary storage unit 33 is an Erasable Programmable ROM (EPROM), Hard Disk Drive (HDD), removable media, or the like. The auxiliary storage unit 33 stores an operating system (OS), various programs, various tables, and the like. The processor 31 loads the program stored in the auxiliary storage unit 33 into the work area of the main storage unit 32 and executes it, and each component is controlled through the execution of this program. As a result, the center server 30 realizes the function that matches the predetermined purpose. The main storage unit 32 and the auxiliary storage unit 33 are computer-readable recording media.

The communication unit 34 is a communication interface for connecting the center server 30 to the network N1. In one example, the communication unit 34 includes, for example, a Local Area Network (LAN) interface board, a wireless communication circuit for wireless communication, and the like. In this embodiment, the communication unit 34 communicates with the user terminal 20 through the network N1.

Next, the user terminal 20 is, for example, a smart phone, a mobile phone, a tablet terminal, a personal information terminal, a wearable computer (such as a smart watch), or a computer such as a Personal Computer (PC). The user terminal 20 has a processor 21, a main storage unit 22, an auxiliary storage unit 23, an input unit 24, a display 25 and a communication unit 26. The components are connected to each other by a bus. The processor 21, the main storage unit 22, and the auxiliary storage unit 23 are the same as the processor 31, the main storage unit 32, and the auxiliary storage unit 33 of the center server 30, so descriptions thereof will be omitted.

The input unit 24 is a device that receives an input operation performed by a user. In one example, the input unit 24 is a touch panel, mouse, keyboard, push buttons, or the like. The display 25 is a device that presents information to the user. In one example, the display 25 is a Liquid Crystal Display (LCD), an Electro Luminescence (EL) panel, or the like. Note that the input unit 24 and the display 25 may be configured as one touch panel display.

The communication unit 26 is a communication interface for connecting the user terminal 20 to the network N1. The communication unit 26 supports mobile communication services (e.g., 6th Generation (6G), 5th Generation (5G), 4th Generation (4G), 3rd Generation (3G), or a telephone communication network such as Long Term Evolution (LTE)), Wi-Fi (registered trademark), or a wireless communication network such as Bluetooth (registered trademark), A user terminal 20 is connected to the network N1. In this embodiment, the communication unit 26 communicates with the center server 30 through the network N1.

### Functional Configuration of Center Server

Next, the function of the center server 30 will be described. FIG. 3 is a diagram showing an example of a functional configuration of the center server 30. The center server 30 has a control unit 300 and a storage unit 310 as functional components. Control unit 300 is achieved by processor 31 of center server 30 executing a computer program stored in auxiliary storage unit 33. At least part of the control unit 300 may be achieved by a hardware circuit such as an Application Specific Integrated Circuit (ASIC) or a Field Programmable Gate Array (FPGA). The storage unit 310 includes databases such as a vehicle information DB 311, an item information DB 312, a charge information DB 313, and the like.

The control unit 300 receives a request specifying an item to be added to the vehicle 10 from the user terminal 20. As an example, the control unit 300 accepts the request by interacting with the user terminal 20 through the execution of processing by the web server. In that case, the user accesses the web server through the browser of the user terminal 20 and transmits the vehicle identification (ID) of the vehicle 10 (or the user's user ID) to the center server 30 through the user terminal 20. In the center server 30 having received the vehicle ID (or user ID), the control unit 300 generates a list of items suitable for the vehicle 10 based on the vehicle ID (or user ID), and includes the generated list. A user interface screen is displayed on the browser of the user terminal 20. The user inputs an operation to the user terminal 20 to select an item desired to be added to the vehicle 10 from the displayed list. The user terminal 20 that has received the input transmits a request specifying the item selected by the user to the center server 30. The request includes the vehicle ID of the vehicle 10 or the user ID of the user in addition to information identifying the item selected by the user (for example, the name of the item). In the center server 30 that received the request, the control unit 300 determines the charge for adding the specified item to the vehicle 10 based on the vehicle ID (or user ID) and the specified item. Details of the process of determining the charge for adding the designated item to the vehicle 10 will be described later. The control unit 300 causes the browser of the user terminal 20 to display a user interface screen including the determined fee.

The interaction between the center server 30 and the user terminal 20 as described above may be realized by a dedicated application program installed in the user terminal 20 and a predetermined protocol.

Here, vehicle information DB 311, item information DB 312, and charge information DB 313 are explained. The vehicle information DB 311, the item information DB 312, and the charge information DB 313 are databases constructed in the auxiliary storage unit 33 of the center server 30 by the processor 31 of the center server 30 executing a database management system (DBMS) program. These databases may be constructed as relational databases.

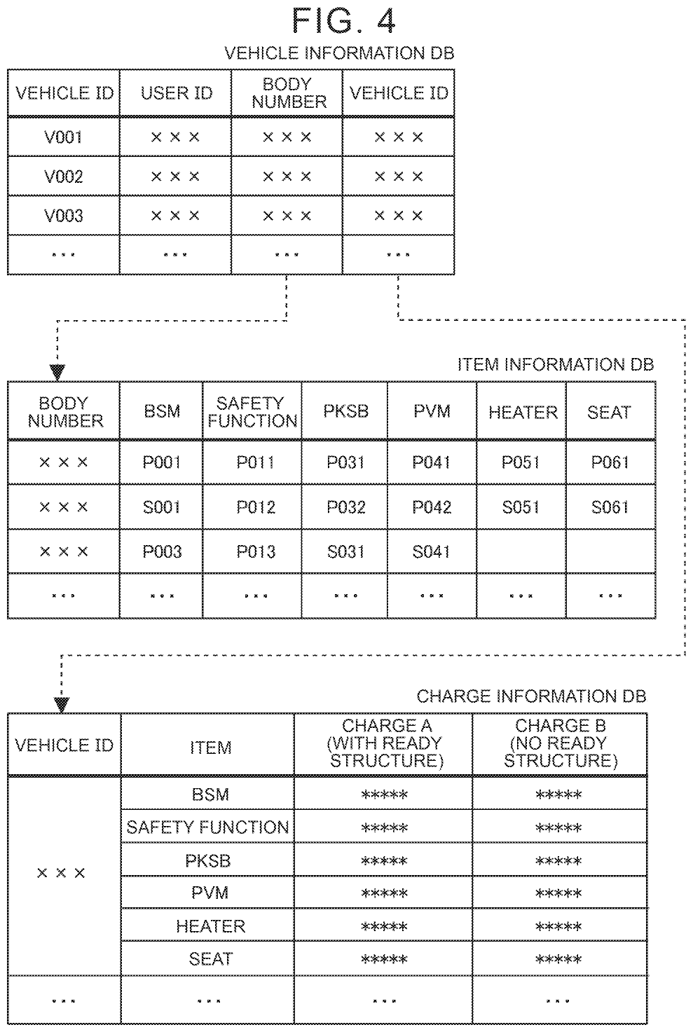

FIG. 4 is a diagram showing an example of information stored in each of the vehicle information DB 311, item information DB 312, and charge information DB 313. First, the vehicle information DB 311 will be explained. The vehicle information DB 311 has records for each vehicle (hereinafter sometimes referred to as “vehicle information records”). Each vehicle information record has fields of a vehicle ID, a user ID, a vehicle body number, and a vehicle model ID, as shown in FIG. 4.

Information (vehicle ID) that can identify the vehicle 10 is registered in the vehicle ID field. Information (user ID) that can identify a user associated with the vehicle 10 is registered in the user ID field. The user ID may be information that can identify the user terminal 20. The body number of the vehicle 10 is registered in the body number field. Since the vehicle body number is unique to each vehicle 10, the vehicle body number may be used as the vehicle ID. Information (vehicle model ID) that can identify the vehicle model of the vehicle 10 is registered in the vehicle model ID field. As for the vehicle model ID, different vehicle model IDs may be set according to the grade and/or model year of the vehicle even if the vehicle model is the same.

Next, the item information DB 312 will be explained. The item information DB 312 has records for each vehicle body number (hereinafter also referred to as “item information records”). Each item information record has fields such as body number, BSM, safety function, PKSB, PVM, heater, and seat, as shown in FIG. 4.

Information corresponding to the vehicle body number field of the vehicle information DB 311 is registered in the vehicle body number field. Information is registered in the BSM, safety function, PKSB, PVM, heater, and seat fields according to whether the vehicle 10 has a ready structure corresponding to each item. In the example shown in FIG. 4, a character string starting with “P” is registered in the field corresponding to the item for which the vehicle 10 having the vehicle body number of interest has a ready structure. As an example, when the wire harness 102 corresponding to the item is attached to the vehicle 10 in advance, a character string beginning with “P” is registered in the field corresponding to the item. This indicates that addition of the wire harness 102 corresponding to the item or replacement of the existing wire harness with the wire harness 102 corresponding to the item is not required in the work of adding the item.

In addition, for items that are not ready-designed for the vehicle 10 having the target vehicle body number and that can be retrofitted by performing incidental work, the field corresponding to the item starts with “S”. A character string is registered. As an example, an item in which the wire harness 102 corresponding to the item is not attached in advance to the vehicle 10, but the wire harness 102 can be added or the existing wire harness can be replaced with the wire harness 102 by performing incidental work, a character string starting with “S” is registered in the field corresponding to the item. This indicates that addition of the wire harness 102 or replacement of the existing wire harness with the wire harness 102 is required in the work of adding the item.

Furthermore, for items that are not ready-designed for the vehicle 10 having the target vehicle body number and that cannot be retrofitted even if incidental work is performed, the field corresponding to the item is left blank. As an example, the wire harness 102 corresponding to the item is not attached to the vehicle 10 in advance, and even if the wire harness 102 is added and the existing wire harness is replaced with the wire harness 102, normal operation is possible. For items that cannot be performed, the field corresponding to the item is left blank. This indicates that the item does not fit (cannot be attached) to the vehicle 10 having the subject vehicle body number. Therefore, blank items are excluded from the aforementioned list (the list of items compatible with the vehicle 10).

Information registered in the item information DB 312 in the present embodiment is an example of first information according to the present disclosure.

Next, the charge information DB 313 will be explained. The charge information DB 313 has records for each vehicle model ID (hereinafter sometimes referred to as “charge information record”). Each charge information record has vehicle model ID, item, charge A, and charge B fields. Information corresponding to the vehicle type field of the vehicle information DB 311 is registered in the vehicle model ID field. A list of items is registered in the item field. In the charge A field, a charge for each item (a charge for adding each item) in the case where the target vehicle type has a ready structure is registered. In the charge B field, a charge for each item (a charge for adding each item) is registered when the target vehicle type does not have a ready structure.

Details of the process of determining the charge for adding the designated item to the vehicle 10 will now be described. First, based on the vehicle ID (or user ID) and the specified item, the control unit 300 determines whether the vehicle 10 has a ready structure corresponding to the specified item. Specifically, the control unit 300 accesses the vehicle information DB 311 and identifies the vehicle information record corresponding to the vehicle ID (or user ID). Control unit 300 acquires information registered in the vehicle body number field of the identified vehicle information record. The control unit 300 accesses the item information DB 312 and identifies the item information record corresponding to the acquired vehicle body number. The control unit 300 refers to the information registered in the field corresponding to the designated item in the specified record. At that time, if a character string starting with “P” is registered in the reference field, the control unit 300 determines that the vehicle 10 has a ready structure corresponding to the designated item. On the other hand, if a character string beginning with “S” is registered in the reference field, control unit 300 determines that vehicle 10 does not have a ready structure corresponding to the designated item.

Next, the control unit 300 acquires information registered in the vehicle model ID field of the vehicle information record specified above. The control unit 300 accesses the charge information DB 313 and identifies the charge information record corresponding to the acquired vehicle model ID. The control unit 300 determines the charge for adding the specified item to the vehicle 10 based on the information registered in the specified charge information record, the above determination result, and the specified item. As an example, when it is determined that the specified item is BSM and the vehicle 10 has a ready structure corresponding to BSM, the control unit 300 selects the BSM to be the charge for adding the specified item to the vehicle 10. Further, when it is determined that the designated item is BSM and the vehicle 10 does not have a ready structure corresponding to BSM, the control unit 300 determines a charge corresponding to BSM, among charges registered in the charge B field, as the charge for adding the specified item to the vehicle 10.

### Process Flow

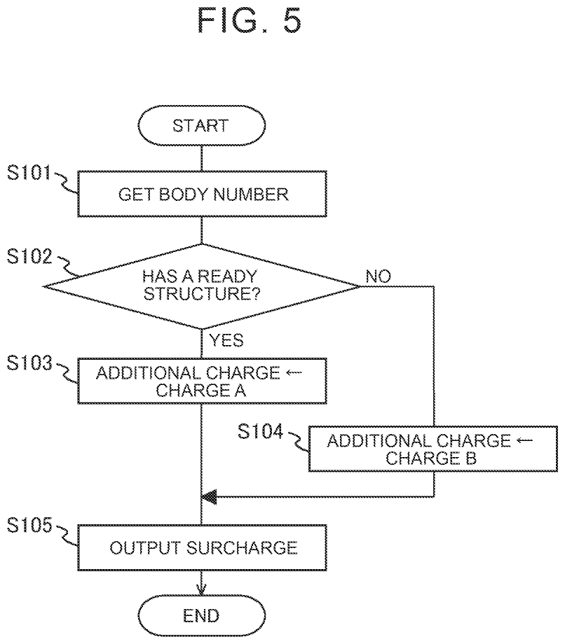

Next, the process in the center server 30 will be described. FIG. 5 is a flowchart showing a processing flow performed by the center server 30 according to the embodiment. The processing flow illustrated in FIG. 5 is triggered by receiving a request specifying an item to be added to the vehicle 10 from the user terminal 20. Note that although the processor 31 of the center server 30 is the subject of execution of this processing flow, the control unit 300, which is a functional component of the center server 30, will be described here as the subject of execution.

When the center server 30 receives a request to add an item to the vehicle 10 from the user terminal 20, the control unit 300 acquires the vehicle body number of the vehicle 10 (S101). Specifically, the control unit 300 accesses the vehicle information DB 311 to identify the vehicle 10 table in which information matching the vehicle ID included in the request is registered in the vehicle ID field. Control unit 300 acquires information (vehicle number) registered in the vehicle number field of the specified vehicle information record.

If a user ID is included in the request, the control unit 300 accesses the vehicle information DB 311 to identify a vehicle information record in which information matching the user ID is registered in the user ID field. You may make it Then, control unit 300 may acquire information (vehicle number) registered in the vehicle number field of the identified vehicle information record.

After completing the processing of S101, the control unit 300 executes the processing of S102.

At S102, control unit 300 determines whether vehicle 10 has a ready structure corresponding to the specified item. Specifically, the control unit 300 accesses the item information DB 312 and identifies an item information record in which information matching the vehicle body number acquired in S101 is registered in the vehicle body number field. The control unit 300 refers to the information registered in the field corresponding to the designated item in the identified item information record. At that time, if a character string starting with “P” is registered in the reference field, the control unit 300 determines that the vehicle 10 has a ready structure corresponding to the designated item (affirmative determination in S102). On the other hand, if a character string starting with “S” is registered in the reference field, the control unit 300 determines that the vehicle 10 does not have a ready structure corresponding to the specified item (in S102 negative judgment).

When an affirmative determination is made in S102, the control unit 300 proceeds to the process of S103 and determines the charge A as the charge for adding the designated item to the vehicle 10. Specifically, the control unit 300 acquires information (vehicle model ID) registered in the vehicle model ID field of the vehicle information record specified in S101. The control unit 300 accesses the charge information DB 313 and identifies a charge information record in which information matching the acquired vehicle model ID is registered in the vehicle model ID field. The control unit 300 determines the charge corresponding to the designated item among the charges registered in the charge A field of the identified charge information record as the charge for adding the designated item to the vehicle 10.

If a negative determination is made in S102, the control unit 300 proceeds to S104 and determines the charge B as the charge for adding the designated item to the vehicle 10. Specifically, the control unit 300 acquires information (vehicle model ID) registered in the vehicle model ID field of the vehicle information record specified in S101. The control unit 300 accesses the charge information DB 313 and identifies a charge information record in which information matching the acquired vehicle model ID is registered in the vehicle model ID field. The control unit 300 determines the charge corresponding to the designated item among the charges registered in the charge B field of the identified charge information record as the charge for adding the designated item to the vehicle 10.

After completing the processing of S103 or S104, the control unit 300 executes the processing of S105. At S105, the control unit 300 outputs the charge determined at S103 or S104. In one example, the control unit 300 causes the browser of the user terminal 20 to display a user interface screen including the determined fee.

When the control unit 300 finishes executing the process of S105, the process flow of FIG. 5 ends.

In the present embodiment described above, the charge for adding the item to the target vehicle is determined according to whether or not the target vehicle has the designated item and the ready structure corresponding to the item. As a result, even if the specified item is the same, it is possible to differentiate the toll between a vehicle having a ready structure corresponding to the item and a vehicle not having the ready structure corresponding to the item. Moreover, even if the target vehicle is the same, the fee can be varied according to the designated item. As a result, it is possible to appropriately determine the charge for adding the retrofit item to the vehicle.

Also, in this embodiment, the determined charge can be displayed on the user terminal. Thereby, the user can be notified of the charge for adding the retrofit item to the vehicle.

Furthermore, in the present embodiment, since the center server determines whether the vehicle has the ready structure, the user does not need to separately check whether the vehicle has the ready structure.

### Other Embodiments

The above-described embodiments are merely examples, and the present disclosure may be appropriately modified and implemented without departing from the scope thereof. The processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. Non-transitory computer-readable storage media include, for example, any type of disk including magnetic disks (floppy disks, hard disk drives (HDD), etc.), and optical disks (CD-ROMs, DVD disks, Blu-ray disks, etc.), read only memory (ROM), random access memory (RAM), EPROM, EEPROM, magnetic cards, flash memory, optical cards, any type of medium suitable for storing electronic instructions.

What is claimed is:

1. An information processing device comprising a control unit that executes:
acquiring a request for adding an item to a vehicle;
acquiring first information that is information according to whether the vehicle is structured such that the item is added;
determining a charge for adding the item to the vehicle based on the first information and information about the item; and
outputting information about the charge.

2. The information processing device according to claim 1, wherein outputting the information about the charge includes transmitting a command that causes a display of a user terminal of the vehicle to display the information about the charge.

3. The information processing device according to claim 1, wherein the information according to whether the vehicle is structured such that the item is added includes information about whether a wire harness connectable to the item is attached to the vehicle.
